(19) United States
(12) Patent Application Publication
(10) Pub. No.: US 2026/0252560 A1
(43) Pub. Date: Aug. 27, 2026

(54) HYBRID QUERY PROCESSING WITH HARDWARE ACCELERATORS

(71) Applicant: Microsoft Technology Licensing, LLC, Redmond, WA (US)

(72) Inventors: Bailu DING, Bellevue, WA (US); Yinan LI, Redmond, WA (US); Surajit CHAUDHURI, Kirkland, WA (US); Johannes Ernst GEHRKE, Bellevue, WA (US)

(21) Appl. No.: 19/065,886

(22) Filed: Feb. 27, 2025

(51) Int. Cl. G06F 16/2453

(52) U.S. Cl. CPC G06F 16/24542

(57) ABSTRACT

The present disclosure relates to systems and methods that perform hybrid query processing using a central processing unit and a graphics processing unit. The systems and methods produce an offloaded query plan for processing by a graphics processing unit. The systems and methods generate filtered data for the offloaded query plan and transfer the offloaded query plan and the filtered data to the graphics processing unit.

### BACKGROUND

A graphics processing unit (GPU) provides lots of compute resources, but the memory capacity in a GPU is limited, i.e., A 100 with 80 gigabytes (GB) of high-bandwidth memory (HBM). The memory capacity of a GPU is typically too small for data analytics workloads with, for example, hundreds of GB to terabytes of data. Storing all the data in GPU memory for analytic workloads is unrealistic. In addition, using a GPU is expensive. While working memory for each query can fit into the GPU memory, the data transfer from a central processing unit (CPU) to GPU is slow, i.e., via PCIe.

### BRIEF SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some implementations relate to a method. The method includes receive a query. The method includes producing an offloaded query plan in response to performing query optimization on the query. The method includes loading data for the offloaded query plan. The method includes outputting filtered data for the offloaded query plan in response to performing data filtering on the data. The method includes transferring, to a query execution engine on the graphics processing unit, the filtered data and the offloaded query plan. The method includes receiving, from the query execution engine on the graphics processing unit, a query result for the offloaded query plan in response to the graphics processing unit executing the offloaded query plan with the filtered data.

Some implementations relate to a device. The device includes a memory to store data and instructions; a graphics processing unit operable to communicate with the memory; and a central processing unit operable to communicate with the memory and the graphics processing unit, wherein the central processing unit includes a database engine operable to: receive a query; produce an offloaded query plan in response to performing query optimization on the query; load data for the offloaded query plan; output filtered data for the offloaded query plan in response to performing data filtering on the data; transfer, to a query execution engine on the graphics processing unit, the filtered data and the offloaded query plan; and receive, from the query execution engine on the graphics processing unit, a query result for the offloaded query plan in response to the graphics processing unit executing the offloaded query plan with the filtered data.

Some implementations relate to a method. The method includes producing an offloaded query plan for a query that identifies a portion of the query for processing by a graphics processing unit. The method includes generating, for the offloaded query plan, a data filter plan with relations, a predicate filter on the relations, and bitmap filters created from probing the relations. The method includes performing, using the data filter plan, a scan of a table. The method includes evaluating, using the data filter plan, the predicate filter. The method includes probing, using the data filter plan, the bitmap filters. The method includes producing filtered data from the table for the offloaded query plan in response to evaluating the predicate filter and the probing of the bitmap filters. The method includes transferring, to the graphics processing unit, the filtered data.

Some implementations relate to a device. The device includes a memory to store data and instructions; a graphics processing unit operable to communicate with the memory; and a central processing unit operable to communicate with the memory and the graphics processing unit, wherein the central processing unit is operable to: produce an offloaded query plan for a query that identifies a portion of the query for processing by a graphics processing unit; generate, for the offloaded query plan, a data filter plan with relations, a predicate filter on the relations, and bitmap filters created from probing the relations; perform, using the data filter plan, a scan of a table; evaluate, using the data filter plan, the predicate filter; probe, using the data filter plan, the bitmap filters; produce filtered data from the table for the offloaded query plan in response to evaluating the predicate filter and the probing of the bitmap filters; and transfer, to the graphics processing unit, the filtered data.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for hybrid query processing using a central processing unit and a graphics processing unit in accordance with implementations of the present disclosure.

FIG. 2 illustrates an example architecture of data filtering in the CPU in accordance with implementations of the present disclosure.

FIG. 3 illustrates an example method for hybrid query processing using a central processing unit and a graphics processing unit in accordance with implementations of the present disclosure.

FIG. 4 illustrates an example method for data filtering in accordance with implementations of the present disclosure.

FIG. 5 illustrates components that may be included within a computer system.

### DETAILED DESCRIPTION

This disclosure generally relates to query processing. Database operators are typically compute intensive or input/output (IO) intensive operations. A graphics processing unit (GPU) provides lots of compute resources, but the memory capacity in a GPU is limited, i.e., A100 with 80 GB of high-bandwidth memory (HBM). The memory capacity of a GPU is typically too small for data analytics workloads with, for example, hundreds of GB to terabytes of data. Storing all the data in GPU memory for analytic workloads is unrealistic. In addition, using a GPU is expensive. The data transfer from a central processing unit (CPU) to GPU is slow, i.e., via Peripheral Component Interconnect Express (PCIe). Thus, difficulties exist in trying to use the computational power of the GPU in query processing.

The present disclosure provides systems and methods that perform hybrid query processing with hardware accelerators. In some implementations, the systems and methods perform hybrid query processing using a central processing unit and a graphics processing unit. The systems and methods leverage the large dynamic random-access memory (DRAM) of the CPU and the high computation and high memory bandwidth in the GPU for accelerating query processing in a cost effective manner. The systems and methods use a hybrid query processing that processes the compute-intensive operators using a GPU and processes IO intensive operators in the CPU at line rate before transferring to the GPU via PCIe. The systems and methods perform data reduction and data compression to reduce the amount of data transfer from the CPU to a GPU via the PCIe. The present disclosure includes a number of practical applications that provide benefits and/or solve problems associated with query processing. Examples of these applications and benefits are discussed in further detail below.

In some implementations, the systems and methods identify an offloaded query plan with a portion of the query to provide to the GPU for processing. The systems and methods aggressively filter the data for the offloaded query plan prior to transferring the offloaded query plan to the GPU. In some implementations, the systems and methods use a data filter plan to filter the data sent to the GPU for the offloaded query plan. Filtering the data for the offloaded query plan reduces the cost of data transfer and the working memory required to execute the query in the GPU. The GPU processes the offloaded query plan using the filtered data and provides a query result to the CPU. The CPU processes the query results from the GPU and the query results provided by the CPU to return the final query result.

In some implementations, the systems and methods use distributed database systems. In some implementations, the systems and methods use hybrid processing on two hardware devices with different specifications connected via a slow link. One example includes the systems and methods performing data filtering operations on a field programmable gate array (FPGA) (e.g., loading data from a solid-state drives (SSDs) and performing the remaining processing on the CPU, which is connected to the FPGA via PCIe. Another example includes the systems and methods performing data reduction on remote storage with some compute resources, e.g., a data processing unit (DPU), before transferring the data to the compute nodes.

One technical advantage of the systems and methods of the present disclosure is accelerating query processing by using both the GPU and the CPU for query processing. Another technical advantage of the systems and methods of the present disclosure is data filtering reducing an amount of data transferred from the CPU to the GPU for use in the query processing. Another technical advantage of the systems and methods of the present disclosure is data compression to reduce the amount of data transferred from the CPU to the GPU. Another technical advantage of the systems and methods of the present disclosure is data reduction. The systems and methods leverage hardware instructions and vectorization in implementing data reduction. Another technical advantage of the systems and methods of the present disclosure is reducing the memory requirement on the GPU allowing queries to run on larger scale databases.

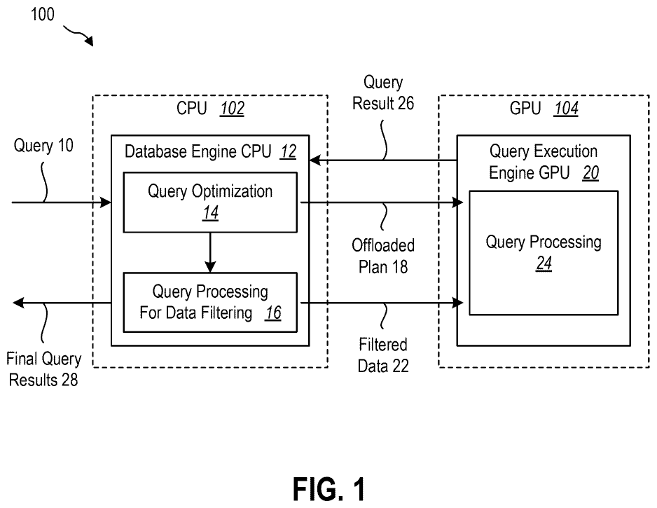

Referring now to FIG. 1, illustrated is an example environment 100 for hybrid query processing using a CPU 102 in communication with a GPU 104. The CPU 102 includes a database engine 12 that receives a query 10. A database engine 12 is used by a database management system to create, read, update, and delete data from a database. In some implementations, the query 10 is a database operation. For example, the query 10 is a join operation. For example, the query 10 is submitted to the database on the CPU 102. In some implementations, a distributed database system is used, and the queries are submitted from a frontend database node to a backend database node.

In some implementations, the database engine 12 performs a query optimization 14 on the query 10. The query optimization 14 produces an offloaded query plan 18 for sending a portion of the query 10 to a query execution engine 20 on the GPU 104 for query processing 24. The offloaded query plan 18 is a subplan of the original query plan. In some implementations, the offloaded query plan 18 includes joins, aggregates, or other operators. In some implementations, the offloaded query plan 18 identifies a single part of the query 10 for sending to the query execution engine 20 on the GPU 104. For example, the offloaded query plan 18 identifies a join in the query 10 to offload to the GPU 104. Another example includes the offloaded query plan 18 identifies an aggregate in the query 10 to offload to the GPU 104. In some implementations, the offloaded plan 18 identifies a plurality of parts of the query 10 for sending to the query execution engine 20 on the GPU 104. For example, the offloaded query plan 18 identifies a join and an aggregate from the query 10 to offload to the GPU 104. Another example includes the offloaded query plan 18 identifies three different joins in the query 10 to offload to the GPU 104.

In some implementations, the database engine 12 performs data filtering 16, processing the offloaded query plan 18, and generating filtered data 22 for the offloaded query plan 18. The database engine 12 loads relevant data from the storage engine based on the query 10. In some implementations, the database engine 12 performs aggressive data filtering 16 on the CPU 102 for the offloaded query plan 18 generating the filtered data 22 for the offloaded query plan 18 (e.g., the portion of the query 10 to transfer to the GPU 104 for processing). In some implementations, the filtered data 22 is a minimum amount of data needed to produce a result for the offloaded query plan 18. Generating the filtered data 22 for the offloaded query plan 18 reduces the amount of data transferred to the GPU 104 for processing.

In some implementations, the database engine 12 transfers the offloaded query plan 18 and the filtered data 22 to the query execution engine 20 on the GPU 104. For example, the offloaded query plan 18 and the filtered data 22 are transferred via a PCIe bus to the GPU 104. The query execution engine 20 on the GPU 104 executes the offloaded query plan 18 using the filtered data 22 and sends back the query result 26 to the database engine 12 in the CPU 102.

In some implementations, if a plurality of parts of the query 10 are identified in the offloaded query plan 18, the step of data filtering 16, data transfer, and GPU execution may occur multiple times until all the offloaded subplans have been executed by the GPU 104. While one GPU 104 is illustrated, the environment 100 may include a plurality of GPUs in communication with the CPU 102 that are used to process the offloaded query plan 18.

The database engine 12 on the CPU 102 receives the query result 26 from the query execution engine 20 on the GPU 104 and performs coordination of the plan execution and postprocessing of query results from the CPU 102 to return the final query result 28. In some implementations, the final query result 28 is provided to a user that provided the query 10. In some implementations, the final query result 28 is provided to another application that provided the query 10.

The environment 100 leverages the large DRAM of the CPU 102 and the high computation and high memory bandwidth in the GPU 104 accelerating query processing in a cost effective manner using both the CPU 102 and the GPU 104 for processing the query 10.

In some implementations, one or more computing devices (e.g., servers and/or devices) are used to perform the processing of the environments 100. The one or more computing devices may include, but are not limited to, server devices, cloud virtual machines, personal computers, a mobile device, such as, a mobile telephone, a smartphone, a PDA, a tablet, a laptop, and/or a non-mobile device. The features and functionalities discussed herein in connection with the various systems may be implemented on one computing device or across multiple computing devices. For example, the CPU 102 and the GPU 104 are implemented on a single computing device. Moreover, in some implementations, one or more subcomponent of the feature and functionalities discussed herein may be implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

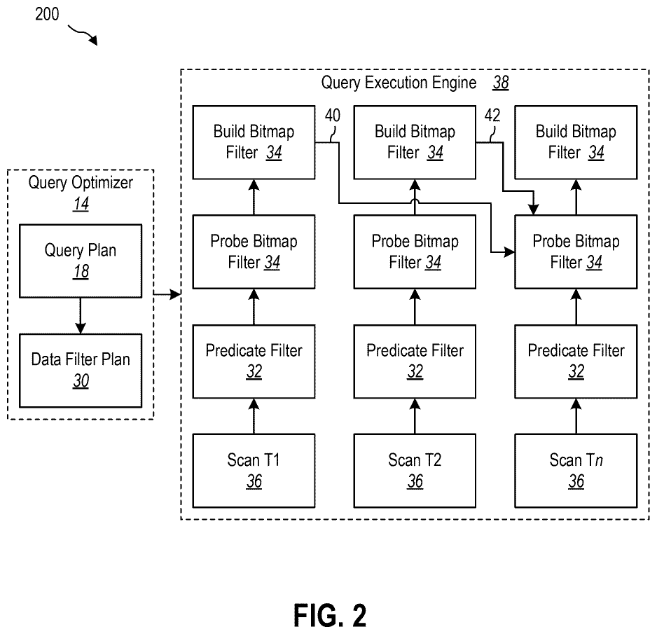

FIG. 2 illustrates an example architecture 200 of the data filtering 16 (FIG. 1) performed in the CPU 102 (FIG. 1) by the database engine 12 (FIG. 1). The database engine 12 performs the data filtering 16 reducing the cost of data transfer and the working memory required to execute the offloaded query plan 18 for the query 10 (FIG. 1) in the GPU 104 (FIG. 1).

The database engine 12 performs the query optimization 14 producing the offloaded query plan 18 and a data filter plan 30 for data filtering of the offloaded query plan 18. The data filter plan 30 is derived from the original offloaded query plan 18 to reduce the data that is not needed for the query result. The data filter plan 30 consists of relations, predicate filters 32 on the relations, and the bitmap filters 34 created from and probed by the relations. The data filter plan 30 includes the dependencies of where the bitmap filter 34 is built from (i.e., columns in the source table) and where the corresponding bitmap filter 34 is probed (i.e., the columns in the destination table). The predicate filter 32 specifies the condition under which the data needs to be satisfied. Examples of predicate filters 32 include point lookup (i.e., value=10), range filter (i.e., value BETWEEN 1 AND 10), and string-based filters (i.e., IN predicates and LIKE predicates).

The bitmap filter 34 (or bitvector filter) is a type of data structure that is used for exact or approximate membership testing with no false negatives. Examples of data structures used as bitmap filters 34 include bits (i.e., 1-1 mapping from value to bit locations) and Bloom filters. The bitmap filter 34 enables membership testing to eliminate the tuples from one relation that do not have a matching tuple when joining with the other relation. Bitmap filtering can be both exact and approximate (i.e., allowing false positives). For example, bitmaps data structures (i.e., exact), hash filters data structures (i.e., approximate), and Bloom filters data structures (i.e., approximate).

When joining two relations, a bitmap filter 34 can be created with the join column from the build side and then probe the bitmap filter 34 with the rows from the probe side before the join. Thus, the amount of data from the probe side that needs to be joined with the build side can be reduced using the bitmap filter 34. The bitmap filter 34 derived from the join graph of the query 10 can be used for aggressive data reduction in hybrid query processing to reduce data transfer from the CPU 102 to the GPU 104.

The evaluation of the predicate filters 32 and the creation and probing of bitmap filters 34 come with a cost. In some implementations, the database engine 12 performs a determination on whether to create the data filter plan 30 based on the overhead costs of evaluating the predicate filters 32 and probing the bitmap filters 34. The database engine 12 estimates the cost of evaluating the predicate filters on the CPU 102 and the cost of applying the predicate filters and uses the estimates of the cost in determining whether to create the data filter plan 30.

In some implementations, the database engine 12 optimizes the placement of bitmap filters 34 by removing non-selective bitmap filters from the data filter plan 30. In some implementations, the database engine 12 consolidates transitive and duplicate bitmap filters 34 with data filter plan 30. In some implementations, the database engine 12 selects a subset of bitmap filters that strike a balance between overhead costs and data reduction for the data filter plan 30. In some implementations, the database engine 12 optimizes the placement of bitmap filters by using a combination of techniques (e.g., consolidating duplicate bitmap filters and removing non-selective bitmaps from the data filter plan 30).

In some implementations, the database engine 12 decides that the bitmap filters 34 are beneficial in data filtering in the offloaded query plan 18 and creates the data filter plan 30. The data filter plan 30 includes both bitmap filters 34 and the predicate filters 32 and the database engine 12 evaluates the overhead and benefit of each filter separately when deciding whether to include the filter in the data filter plan 30. The overhead of predicate filters 32 comes from evaluating the predicate filters 32 on the data. The overhead of the bitmap filters 34 comes from creating the bitmap filter 34 with the build side table and probing the bitmap filter 34 with the probe side table. For example, the database engine 12 determines that the benefit of data reduction using the bitmap filter 34 outweighs the overhead costs of probing the bitmap filters 34 and includes the bitmap filters 34 in the data filter plan 30. Another example includes the database engine 12 determines the benefit of data reduction using the predicate filters 32 outweighs the overhead costs of evaluating the predicate filters 32 (e.g., the predicate filters 32 can be evaluated efficiently on the CPU 102) and includes the predicate filters 32 in the data filter plan 30. Another example includes the database engine 12 determines the benefit of data reduction using the predicate filters 32 and the bitmap filters 34 outweighs the overhead costs of the predicate filters 32 and the bitmap filters 34 and includes both the predicate filters 32 and the bitmap filters 34 in the data filter plan 30.

In some implementations, the database engine 12 determines to skip the data filter plan 30 in response to determining that the overhead costs of evaluating the predicate filters 32 and probing the bitmap filters 34 are unbeneficial. In some implementations, the construction of data filter plan 30 by the database engine 12 is cost-based.

In some implementations, the data filter plan 30 includes multiple bitmap filters 34. For example, multiple bitmap filters 34 are built from different columns of one table. Each bitmap filter 34 can be probed by one or more tables, and a table can probe multiple bitmap filters 34 on the same or different columns in that table. In some implementations, the database engine 12 analyzes the offloaded query plan 18 and the join graph of the offloaded query plan 18, deriving a dependency graph to create and apply multi-level bitmap filters 34 from the base tables in the offloaded query plan 18. The database engine 12 uses a cost-based manner to selectively create bitmap filters 34 based on the overhead of the bitmap filters creation and application.

In some implementations, that database engine 12 includes a query execution engine 38 that performs the data filtering 16 using the data filter plan 30. The query execution engine 38 performs the scans of the tables based on the dependency of the bitmap filters 34. For example, a table can be scanned as soon as all of the bitmap filters 34 that the query execution engine 38 needs to probe are built. After scanning a table, the predicate filter 32 is evaluated by the query execution engine 38, the bitmap filters 34 are probed for further data reduction, and the bitmap filters 34 that need to be built from this table are created based on the filtered data. In some implementations, the bitmap filters 34 are built from different tables and are used in the data filter plan 30. One example includes a bitmap filter B1 is built from T1, and bitmap filter B1 is probed by T2, bitmap filter B2 is built from the reduced data from T2, and bitmap filter B2 is probed by T3. The filtered data 22 (FIG. 1) from each table is transferred to the GPU 104 for the execution of the offloaded query plan 18.

In the illustrated example, dependencies 40, 42 exist between a bitmap filter 34 built for table (T1) and a bitmap filter 34 built for table (T2). Both bitmap filters 34 are probed in the table (Tn). The filtered data 22 from each table (table T1, table T2, and table Tn) is transferred to the GPU 104 for executing the offloaded query plan 18.

In some implementations, the query execution engine 38 sends the filtered data 22 from each table in compressed form to the GPU 104 for executing the offloaded query plan 18. The input table is stored in a columnar representation and each column of the table is stored in a compressed representation. For example, each column is compressed using Run-Length Encoding (RLE), bit-packing encoding, or dictionary encoding (i.e., string columns). The query execution engine 38 evaluates all filters and generates a selection bitmap filter 34 that indicates which rows match all filters. For example, if a column has five rows, a selection bitmap filter of 00111 indicates that the last three rows pass the filter. For each column accessed by the offloaded query plan 18, query execution engine 38 extracts the values from the selected rows and sends the filtered results (e.g., the filtered data 22) to the GPU 104 for processing. The filtered values are also in compressed form, using the same encoding as the input column values (e.g., RLE, bit-packing encoding, or dictionary encoding).

In some implementations, the input column values are encoded using RLE encoded values. The query execution engine 38 generates a filtered RLE encoded run that includes exactly the selected values. For example, the input RLE run contains k occurrences of a value v. To generate the filtered run, the query execution engine 38 calculates the number of selected values among the k occurrences based on the selection bitmap filter 34 and produces a filtered run containing the exact number of v. The filtered data 22 is in the same form as the input column values (e.g., RLE encoded values).

In some implementations, the input column values are encoded using bit-packing. The query execution engine 38 uses an algorithm that takes as input a byte array consisting of n k-bit values and an n-bit selection bitvector. The algorithm extracts all selected values and copies the selected values into the contiguous bits in an output byte array, just as if the bits of all unselected values had been removed from the input. The algorithm uses Bit Manipulation Instructions (BMI) in X86 CPUs, which can manipulate multiple bit-packed values packed in a 64-bit CPU word simultaneously. The query execution engine 38 uses the algorithm to compact selected values, and the generated array contains all selected values that are also in the compressed representation. The filtered compressed values (the filtered data 22) are sent to GPU 104 for further processing. The filtered data 22 is in the same form as the input column values (e.g., compressed using bit-packing).

The query execution engine 38 efficiently implements hardware instructions and vectorization for predicate filtering. The architecture 200 performs data reduction by predicate filtering and bit vector filtering, reducing the amount of data transferred to the GPU 104 for processing the offloaded query plan 18. The architecture 200 reduces the cost of data transfer and the working memory required to execute the offloaded query plan 18 in the GPU 104.

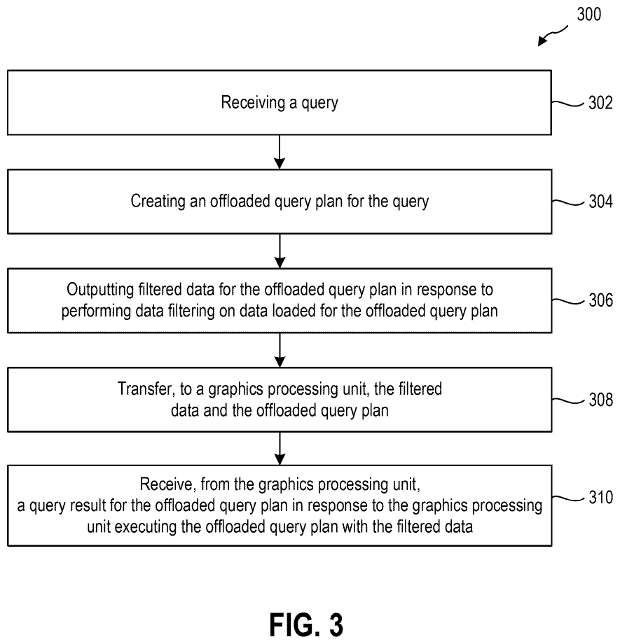

FIG. 3 illustrates an example method 300 for hybrid query processing using a CPU 102 (FIG. 1) and a GPU 104 (FIG. 1). The features of the method 300 are discussed below in reference to FIGS. 1 and 2.

At 302, the method 300 includes receiving a query. In some implementations, the database engine 12 receives a query 10. For example, the query 10 is received from a user. Another example includes the query 10 is received from an application. In some implementations, the query 10 is a database operation.

At 304, the method 300 includes creating an offloaded query plan. In some implementations, the database engine 12 creates the offloaded query plan 18 in response to performing query optimization 14 on the query 10. The offloaded query plan 18 is created from the query optimizer in the database systems based on the capability of the GPU 104 (e.g., the operators supported by the GPU 104). In some implementations, the database engine 12 evaluates whether transferring the offloaded query plan 18 to the GPU 104 is faster as compared to processing the offloaded query plan 18 on the CPU 102 in determining what portions of the query 10 to include in the offloaded query plan 18. In some implementations, the database engine 12 evaluates the capabilities of the GPU 104 to ensure the GPU 104 has the memory capacity to perform the offloaded query plan 18 in determining what portions of the query 10 to include in the offloaded query plan 18. In some implementations, the offloaded query plan 18 is a portion of the query 10 for execution on the GPU 104. In some implementations, the offloaded query plan 18 is a plurality of parts of the query 10 for execution on the GPU 104.

At 306, the method 300 includes outputting filtered data for the offloaded query plan in response to performing data filtering on data loaded for the offloaded query plan. In some implementations, the database engine 12 outputs filtered data 22 in response to performing data filtering 16 on data loaded for the offloaded query plan 18. For example, the data for the query 10 is initially loaded into the CPU 102 and data filtering 16 is performed to identify what data is necessary to produce the query result 26 for the offloaded query plan 18.

In some implementations, the database engine 12 produces the filtered data 22 using a data filter plan 30 that reduces the data not needed for the query result 26. In some implementations, the data filter plan 30 includes relations, predicate filters 32 on the relations, and bitmap filters 34 created from probing the relations. Outputting filtered data 22 reduces an amount of data transferred to the GPU 104 to use in processing the offloaded query plan 18.

At 308, the method 300 includes transferring, to the GPU, the filtered data and the offloaded query plan. In some implementations, the database engine 12 transfers to the GPU 104 the filtered data 22 and the offloaded query plan 18. In some implementations, the filtered data 22 and the offloaded query plan 18 are transferred via a PCIe bus to the GPU 104.

At 310, the method 300 includes receiving, from the GPU, a query result for the offloaded query plan in response to the GPU executing the offloaded query plan with the filtered data. In some implementations, the database engine 12 receives the query result 26 for the offloaded query plan 18 from the GPU 104 in response to the GPU 104 executing the offloaded query plan 18 with the filtered data 22.

In some implementations, the database engine 12 post processes the query result 26 for the offloaded query plan 18 with query results from for the query 10 from the CPU 102 and returns a final query result 28 for the query 10 using the query result 26 for the offloaded query plan 18 and the query results from the CPU 102.

The method 300 accelerates query processing by leveraging the CPU 102 and the GPU 104, performing a hybrid processing of a query 10.

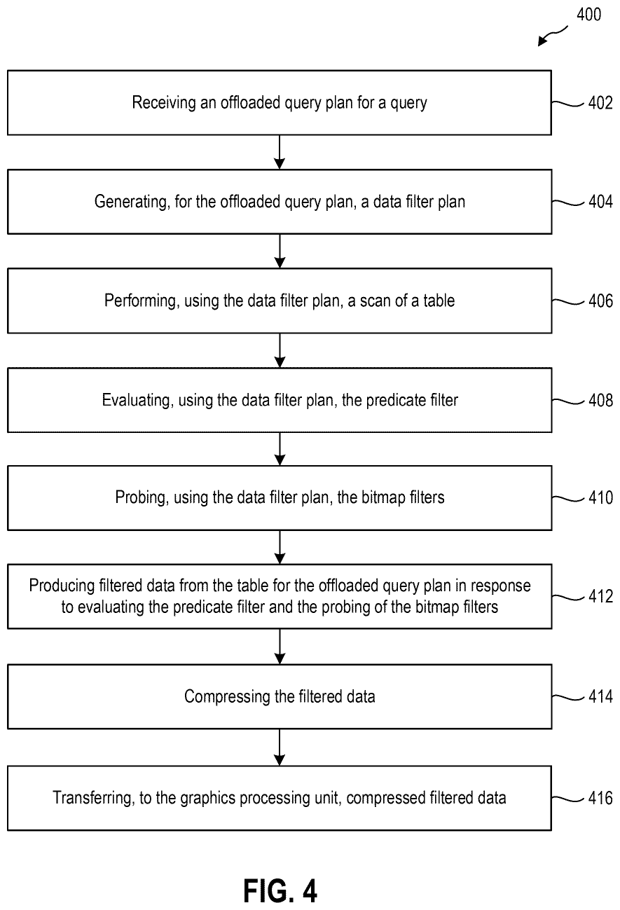

FIG. 4 illustrates an example method 400 for data filtering 16 (FIG. 1). The features of the method 400 are discussed below in reference to FIGS. 1-3.

At 402, the method 400 includes receiving an offloaded query plan for a query. In some implementations, the database engine 12 creates an offloaded query plan that identifies a portion of the query 10 for processing by the GPU 104.

At 404, the method 400 includes generating, for the offloaded query plan, a data filter plan. In some implementations, a database engine 12 generates a data filter plan 30 for the offloaded query plan 18. In some implementations, the data filter plan 30 includes relations, a predicate filter 32 on the relations, and bitmap filters 34 created from probing the relations.

In some implementations, the database engine 12 generates the data filter plan 30 by analyzing a join graph for the offloaded query plan 18, generating a dependency graph for the offloaded query plan 18, and applying, using the dependency graph, multi-level bitmap filters 34 in the offloaded query plan 18. In some implementations, multiple bitmap filters 34 are built from different columns of a single table where each bitmap filter 34 is probed by a plurality of tables.

In some implementations, the bitmap filters 34 are selected for the data filter plan 30 based on an overhead cost of creating the bitmap filters 34. In some implementations, the bitmap filters 34 are selected for the data filter plan 30 by removing non-selective bitmap filters from the data filter plan 30. In some implementations, the bitmap filters 34 are selected for the data filter plan 30 by selecting a subset of bitmap filters that provide data reduction outweighing overhead costs by the CPU 102 in evaluating the subset of bitmap filters.

In some implementations, the bitmap filters 34 are selected based on a data filtering benefit for the offloaded query plan 18. In some implementations, the database engine 12 performs a cost evaluation of the offloaded query plan 18. For example, the cost evaluation estimates a cost of evaluating the predicate filter 32 by the CPU 102. In some implementations, the database engine 12 generates the data filter plan 30 in response to determining that the data reduction for the offloaded query plan 18 outweighs the cost evaluation. In some implementations, the database engine 12 skips generating the data filter plan 30 in response to determining that the data reduction for the offloaded query plan 18 does not outweigh the cost evaluation.

At 406, the method 400 includes performing, using the data filter plan, a scan of a table. In some implementations, a query execution engine 38 performs a scan of a table using the data filter plan 30. In some implementations, the scan of the table consists of multiple steps, including decompressing the data (to the extent necessary for evaluating the filters), evaluating the predicate filter, evaluating bitmap filtering, creating the bitmap filter, if needed, and compressing the data. In some implementations, the scan is performed on the table based on dependencies of the bitmap filters 34.

At 408, the method 400 includes evaluating, using the data filter plan, the predicate filter. In some implementations, the query execution engine 38 decompresses the data from the table to the extent necessary for evaluating the predicate filter 32. Depending on the data type and the type of predicate filter 32, the data may not be fully decompressed, e.g., semi-decompressed so that the predicate filter can be evaluated. In some implementations, the query execution engine 38 evaluates the predicate filter 32 using the data filter plan 30 and filters out data from the table in response to the predicate filter 32 evaluation. For example, if the predicate filter 32 requires values greater than 10, the query execution engine 38 filters out the data from the table that are below 10. In some implementations, the predicate filter 32 reduces a lot of data that is not required by the query.

At 410, the method 400 includes probing, using the data filter plan, the bitmap filters. In some implementations, the query execution engine 38 probes the bitmap filters 34 using the data filter plan 30 and filters out data from the table in response to probing the bitmap filter 34. For example, the bitmap filter 34 joins two relationships and the query execution engine 38 removes the data without matching tuples to the joined relationship.

At 412, the method 400 includes producing filtered data from the table for the offloaded query plan in response to evaluating the predicate filter and the probing of the bitmap filters. In some implementations, the query execution engine 38 produces filtered data 22 from the table for the offloaded query plan 18 in response to evaluating the predicate filter 32 and the probing of the bitmap filters 34. In some implementations, the filtered data 22 is a minimum amount of data needed to provide the query result 26 for the offloaded query plan 18 by the GPU 104.

At 414, the method 400 includes compressing the filtered data. In some implementations, the query execution engine 38 compresses the filtered data 22. In some implementations, the compressed filtered data is compressed using run-length encoding. In some implementations, the compressed filtered data is compressed using bit-packing encoding using a byte array that contains all selected values in a compressed format.

At 416, the method 400 includes transferring, to the graphics processing unit, compressed filtered data. The query execution engine 38 transfers compressed filtered data 22 to the GPU 104.

In some implementations, the database engine 12 receives, from the GPU 104, a query result 26 for the offloaded query plan 18, post processes the query result 26 for the offloaded query plan 18 with query results for the query 10 from the CPU 102, and returns a final query result 28 for the query 10 using the query result 26 for the offloaded query plan 18 and the query results from the CPU 102.

The method 400 is used to filter the data and significantly reduce an amount of data sent to the GPU 104 for processing. By reducing the amount of data sent to the GPU 104, the cost of data transfer and the working memory required to execute the offloaded query plan 18 in the GPU 104 is reduced.

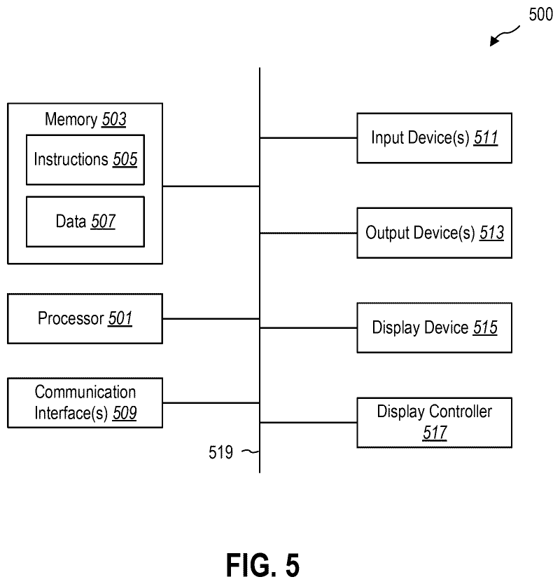

FIG. 5 illustrates components that may be included within a computer system 500. One or more computer systems 500 may be used to implement the various methods, devices, components, and/or systems described herein.

The computer system 500 includes a processor 501. The processor 501 may be a general-purpose single or multi-chip microprocessor (e.g., an Advanced RISC (Reduced Instruction Set Computer) Machine (ARM)), a special purpose microprocessor (e.g., a digital signal processor (DSP)), a graphics processing unit (GPU), a microcontroller, a programmable gate array, etc. The processor 501 may be referred to as a central processing unit (CPU). Although just a single processor 501 is shown in the computer system 500 of FIG. 5, in an alternative configuration, a combination of processors (e.g., an ARM and DSP) could be used.

The computer system 500 also includes memory 503 in electronic communication with the processor 501. The memory 503 may be any electronic component capable of storing electronic information. For example, the memory 503 may be embodied as random-access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 505 and data 507 may be stored in the memory 503. The instructions 505 may be executable by the processor 501 to implement some or all of the functionality disclosed herein. Executing the instructions 505 may involve the use of the data 507 that is stored in the memory 503. Any of the various examples of modules and components described herein may be implemented, partially or wholly, as instructions 505 stored in memory 503 and executed by the processor 501. Any of the various examples of data described herein may be among the data 507 that is stored in memory 503 and used during execution of the instructions 505 by the processor 501.

A computer system 500 may also include one or more communication interfaces 509 for communicating with other electronic devices. The communication interface(s) 509 may be based on wired communication technology, wireless communication technology, or both. Some examples of communication interfaces 509 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 500 may also include one or more input devices 511 and one or more output devices 513. Some examples of input devices 511 include a keyboard, mouse, microphone, remote control device, button, joystick, trackball, touchpad, and lightpen. Some examples of output devices 513 include a speaker and a printer. One specific type of output device that is typically included in a computer system 500 is a display device 515. Display devices 515 used with embodiments disclosed herein may utilize any suitable image projection technology, such as liquid crystal display (LCD), light-emitting diode (LED), gas plasma, electroluminescence, or the like. A display controller 517 may also be provided, for converting data 507 stored in the memory 503 into text, graphics, and/or moving images (as appropriate) shown on the display device 515.

The various components of the computer system 500 may be coupled together by one or more buses, which may include a power bus, a control signal bus, a status signal bus, a data bus, etc. For the sake of clarity, the various buses are illustrated in FIG. 5 as a bus system 519.

In some implementations, the various components of the computer system 500 are implemented as one device. For example, the various components of the computer system 500 are implemented in a mobile phone or tablet. Another example includes the various components of the computer system 500 implemented in a personal computer. Another example includes the various components of the computer system 500 implemented in the cloud. Another example includes the various components of the computer system 500 implemented on an edge device.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining, and the like. Also, “determining” can include receiving (e.g., receiving information), accessing (e.g., accessing data in a memory), and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

1. A device, comprising:
a memory to store data and instructions;
a graphics processing unit operable to communicate with the memory; and
a central processing unit operable to communicate with the memory and the graphics processing unit, wherein the central processing unit includes a database engine operable to:
receive a query;
produce an offloaded query plan in response to performing query optimization on the query;
load data for the offloaded query plan;
generate, for the offloaded query plan, a data filter plan that reduces the data not needed for a query result;
output filtered data for the offloaded query plan in response to performing data filtering on the data using the data filter plan;
transfer, to a query execution engine on the graphics processing unit, the filtered data and the offloaded query plan; and
receive, from the query execution engine on the graphics processing unit, a query result for the offloaded query plan in response to the graphics processing unit executing the offloaded query plan with the filtered data.

2. The device of claim 1, wherein the offloaded query plan is a portion of the query for execution on the graphics processing unit.

3. The device of claim 1, wherein the offloaded query plan is a plurality of parts of the query for execution on the graphics processing unit.

4. (canceled)

5. The device of claim 1, wherein the data filter plan includes relations, predicate filters on the relations, and bitmap filters created from probing the relations.

6. The device of claim 1, wherein the database engine is further operable to:
post process the query result for the offloaded query plan with query results for the query from the central processing unit; and
return a final query result for the query using the query result for the offloaded query plan and the query results from the central processing unit.

7. A method, comprising:
producing an offloaded query plan for a query that identifies a portion of the query for processing by a graphics processing unit;
generating, for the offloaded query plan, a data filter plan with relations, a predicate filter on the relations, and bitmap filters created from probing the relations, wherein the data filter plan includes dependencies identifying where each bitmap filter is built from in a source table and where the bitmap filter is probed in a destination table;
performing, using the data filter plan, a scan of a table based on the dependencies of the bitmap filters;
evaluating, using the data filter plan, the predicate filter;
probing, using the data filter plan, the bitmap filters;
producing filtered data from the table for the offloaded query plan in response to evaluating the predicate filter and the probing of the bitmap filters; and
transferring, to the graphics processing unit, the filtered data.

8. The method of claim 7, wherein the data filter plan is generated by:
analyzing a join graph for the offloaded query plan;
generating a dependency graph for the offloaded query plan; and
applying, using the dependency graph, multi-level bitmap filters in the offloaded query plan.

9. The method of claim 8, wherein multiple bitmap filters are built from different columns of a single table where each bitmap filter is probed by a plurality of tables.

10. The method of claim 7, wherein the bitmap filters are selected for the data filter plan based on an overhead cost of creating the bitmap filters.

11. The method of claim 7, wherein the bitmap filters are selected for the data filter plan by removing non-selective bitmap filters from the data filter plan.

12. The method of claim 7, wherein the bitmap filters are selected for the data filter plan by selecting a subset of bitmap filters that provide data reduction outweighing overhead costs by a central processing unit in evaluating the subset of bitmap filters.

13. The method of claim 7, wherein the bitmap filters are selected based on a data filtering benefit for the offloaded query plan.

14. The method of claim 7, further comprising:
performing a cost evaluation of the offloaded query plan, wherein the cost evaluation estimates a cost of evaluating the predicate filter and a cost of probing the bitmap filters by a central processing unit; and
generating the data filter plan in response to determining data reduction for the offloaded query plan outweighs the cost evaluation.

15. (canceled)

16. The method of claim 7, further comprising:
compressing the filtered data; and
transferring, to the graphics processing unit, compressed filtered data.

17. The method of claim 16, wherein the compressed filtered data is compressed using run-length encoding.

18. The method of claim 16, wherein the compressed filtered data is compressed using bit-packing encoding using a byte array that contains all selected values in a compressed format.

19. The method of claim 7, wherein the filtered data is a minimum amount of data needed to provide a result for the offloaded query plan by the graphics processing unit.

20. The method of claim 7, further comprising:
receiving, from the graphics processing unit, a query result for the offloaded query plan;
processing the query result for the offloaded query plan with query results for the query from a central processing unit; and
returning a final query result for the query using the query result for the offloaded query plan and the query results from the central processing unit.

21. The method of claim 7, wherein the bitmap filters are selected for the data filter plan by consolidating transitive and duplicate bitmap filters in the data filter plan.
